(19) United States
(12) Patent Application Publication
(10) Pub. No.: US 2014/0175020 A1
(43) Pub. Date: Jun. 26, 2014

(54) VARIABLE FLOW SELF-DILUTING FEEDWELL SYSTEM

(71) Applicant: FLSMIDTH A/S, Valby (DK)

(72) Inventor: Timothy J. Laros, Park City, UT (US)

(73) Assignee: FLSMIDTH A/S, Valby (DK)

(21) Appl. No.: 13/726,968

(22) Filed: Dec. 26, 2012

(51) Int. Cl. B01D 21/24; B01D 21/01

(52) U.S. Cl. CPC B01D 21/2405; B01D 21/01
USPC 210/738; 210/207; 210/136; 210/800

(57) ABSTRACT

In a feed dilution system and method for a thickener or settling tank, a feed pipe nozzle has a variable orifice configured to provide an infeed slurry flow stream of substantially constant velocity. The feed pipe orifice is disposed in a mixing conduit proximate an upstream end thereof, while a downstream end of the mixing conduit is functionally attached to a feedwell inside the thickener or settling tank, so that the mixing conduit communicates with the feedwell. Where a diluting liquid is introduced into the mixing conduit, the variable-orifice nozzle ensures a substantially uniform degree of dilution of the influent slurry feed stream by the diluting liquid.

### BACKGROUND OF THE INVENTION

This invention relates to thickener/clarifier settling tanks used to separate liquid and solid components of an influent feed slurry and specifically relates to feedwell apparatus employed in such thickener/clarifiers to enhance the clarification process. More specifically, the invention relates to a feed dilution system and method that delivers a diluted solids slurry to a feedwell of a thickener or clarifier tank.

Thickener/clarifier tanks are used in a wide variety of industries to separate influent feed slurry comprising a solids, or particulate, containing fluid to produce a “clarified” liquid phase having a lower concentration of solids than the influent feed slurry and an underflow stream having a higher concentration of solids than the influent feed slurry. Thickener/clarifier tanks conventionally comprise a tank having a floor and a continuous wall, which define a volume within which the clarification process takes place. Thickener/clarifier tanks also include an influent feed pipe for delivering influent feed to the tank, an underflow outlet for removing settled solids from the tank and a fluid discharge outlet for directing clarified liquid away from the tank. Thickener/clarifier settling tanks may also include a rake assembly having rake arms for sweeping along the floor of the tank, and may include an overflow launder or bustle pipe for collecting clarified liquid near the top of the tank.

Thickener/clarifier tanks of the type described operate by introducing an influent feed stream into the volume of the tank where the influent is retained for a period long enough to permit the solids to settle out by gravity from the fluid. The solids that settle to the bottom of the tank produce a sludge bed near the bottom of the tank, which is removed through the underflow outlet. Clarified liquid is formed at or near the top of the thickener/clarifier tank and is directed away from the tank for further processing or disposal. Settling of solids may be enhanced in some applications by the addition of a flocculent or polymer that forms agglomerates that settle more readily. In many applications, an objective of fluid clarification is to enhance the settling process to achieve a high throughput of solids, and thereby enhance solids recovery.

Many thickener/clarifier tanks are constructed with a feedwell, usually centrally located within the tank, into which the influent feed stream is delivered. The feedwell generally serves the purpose of reducing the fluid velocity of the incoming influent feed stream so that the energy in the stream may be dissipated to some degree before entering the tank. Dissipation of energy in the influent feed stream lessens the disruptive effect that the incoming influent feed has on the settling rate of the solids in the tank. In other words, introduction into a thickener/clarifier of an influent feed stream under high fluid velocity tends to cause turbulence in the tank and compromises the settling rate of solids. A feedwell may be structured in a variety of ways, therefore, to create or enhance dissipation of energy in the influent feed. For example, the feedwell and influent feed pipe may be structured to introduce influent feed to the feedwell at two opposing directions and into an annular space, such as is disclosed in U.S. Pat. No. 4,278,541 to Eis, et al.

In many feedwell assemblies, the influent feed pipe is incorporated into a feed slurry dilution system including a mixing conduit with a downstream end connected to the feedwell and an upstream end that receives both a slurry stream from a feed pipe and a diluting liquid via a pipe, an eductor type structure, or any other source. The mixing conduit may take the form of a classical submerged pipe or tube or alternatively an open channel form in which a mixing zone is open to the atmosphere.

The feed pipe is provided at its outlet end, at the upstream end of the mixing conduit, with a nozzle usually having a circular outlet opening located proximate the upstream end of the mixing conduit. It has been observed that the degree of dilution of the slurry infeed stream is not constant but instead varies with the rate or velocity of slurry inflow. For facilitating process control, it would be desirable to have a uniform degree of slurry dilution.

### OBJECTS OF THE INVENTION

It is an object of the present invention to provide an improved feed slurry dilution system and/or associated method for a feedwell assembly of a thickener/clarifier/settling tank.

A more specific object of the present invention is to provide such a feed slurry dilution system and/or associated method which provides a substantially constant degree of dilution of a feed stream entering a feedwell.

Another specific object of the present invention is to provide such a feed slurry dilution system and/or associated method which is easy and inexpensive to implement.

A related object of the present invention is to provide such a feed slurry dilution system and/or associated method which is easy and inexpensive to implement as a retrofit to feedwell assemblies of existing and operating thickener/clarifier/settling tanks.

These and other objects of the present invention will be apparent from the drawings and description herein. Although every object of the invention is believed to be attained by at least one embodiment of the invention, there is not necessarily any one embodiment of the invention that achieves all of the objects of the invention.

### SUMMARY OF THE INVENTION

Applicants have discovered that if the motive jet, that is, the output stream of the feed pipe nozzle, at the upstream end of the mixing conduit, is regulated to have a substantially constant velocity, one is able to achieve a substantially constant degree of dilution of a feed stream entering a feedwell.

Accordingly, a feed slurry dilution system for a thickener or settling tank comprises, in accordance with the present invention, a slurry feed pipe provided with a nozzle attached to a downstream end of the feed pipe, where the nozzle has a variable orifice configured to provide an infeed slurry flow stream of substantially constant velocity. The feed dilution system for the thickener or settling tank further comprises a mixing conduit, at least a portion of the nozzle being disposed proximate an upstream end of the mixing conduit, and a feedwell disposed inside the thickener or settling tank, a downstream end of the mixing conduit being functionally attached to the feedwell so that the mixing conduit communicates with the feedwell.

Preferably, the nozzle has an outlet orifice portion made of resilient and flexible material such as rubber. Concomitantly, the nozzle may take the form an elastomeric check valve type nozzle, particularly a duckbill type nozzle.

The mixing conduit may be in the form of an open channel or a closed pipe, for instance, a submerged conduit. The mixing conduit may have a variety of cross-sections; e.g., circular, oval, etc. The mixing conduit may also have a rectangular cross-section with a pair of lower corners, the nozzle having an outlet opening configured to bias the infeed slurry flow stream to remove settled particles from the corners. The feed slurry dilution system may also variously include an eductor type structure to facilitate the dilution of the incoming slurry feed stream.

The present invention also relates to associated method of conditioning a slurry feed stream flowing into the feedwell of a thickening or settling tank, where the tank includes a tank inlet system comprising an influent slurry feed pipe and orifice directing the influent slurry feed stream into a mixing conduit, the mixing conduit including a source of diluting liquid, which may also be sometimes referred to as dilutant or diluent, a bottom and leading to the feedwell. The method of the present invention then comprises the steps of (a) flowing the influent slurry feed stream through the feed pipe and orifice into the mixing conduit and using the feed pipe orifice to shape the influent feed stream so that the influent feed stream has a substantially constant velocity on an output side of the orifice, (b) introducing a diluting liquid or otherwise diluting the incoming slurry feed stream, (c) mixing the influent feed stream and the introduced diluting liquid within the mixing conduit thereby forming a diluted and mixed slurry feed stream, and (d) flowing the resulting diluted and mixed slurry feed stream into the feedwell.

The method contemplates that using the feed pipe orifice includes changing or managing the shape and/or the opening size of the feed pipe orifice. The feed pipe orifice may be provided in an elastomeric check valve type nozzle configured and arranged to shape the influent feed stream according to the method. The nozzle may take the particular form of a duckbill type nozzle configured and arranged to shape the influent feed stream into a flattened cross-section.

Pursuant to a feature of the present invention, the feed pipe orifice is made at least in part of resilient and flexible material configured and arranged to shape the influent feed stream according to the method.

The method preferably further comprises feeding a diluting liquid to the mixing conduit to mix with the influent slurry feed stream, wherein the using of the feed pipe orifice to shape the influent feed stream so that the influent feed stream has a constant velocity ensures a substantially uniform degree of dilution of the influent slurry feed stream by the diluting liquid.

The method may include the additional steps of (i) educting the flow of the diluting liquid into the mixing channel by way of transfer of momentum between the influent slurry feed stream and the diluting liquid, (ii) flocculating the educted diluting liquid, or flocculating the slurry feed stream and the diluting liquid within the mixing channel, and (iii) producing a substantially uniform solids concentration within the resulting diluted and mixed slurry feed stream flowing into the feedwell.

Changing or otherwise managing the shape and/or the opening size of the orifice in turn shapes the influent feed stream according to the method.

It is to be noted that if a duckbill type variable-orifice nozzle is oriented with the elongate orifice dimension extending across the mixing conduit or channel, the influent slurry flow stream or slurry infeed stream is non-circular and flatter and thus broader across the width of the channel instead of a tubular stream flowing down the center of the mixing channel. This flattened slurry infeed stream is more conducive to mixing the solids and dilution fluids together in an area closer to the dilution-liquid suction or eduction inlet of the mixing channel and that the flows are better mixed prior to the exit from the mixing channel, hence producing a more uniform solids concentration over the entire open channel as it enters the feedwell.

The nozzle may be rotatably, snap fit, bolted, or otherwise mounted to the feed pipe and it may be removable and/or replaceable.

The mixing conduit may take any number of forms, including that of an open or closed channel having a substantially rounded, v-shaped, rectangular or approximately rectangular cross-section with one or more sharp or rounded lower corners. The outlet opening of the nozzle may be asymmetrically configured to bias the initial stream to remove settled particles from the corners of the mixing conduit.

A feedwell feed slurry dilution system provided with a variable orifice nozzle in accordance with the present invention helps keep an open channel system scoured and cleaned and allows for a variable incoming flow rate volume while the valve keeps the nozzle velocity more or less constant as the valve clamps down a bit as the flow rate decreases. This is of particular benefit in generally rectangular open-channel type mixing conduits where the invention results not only in a more even or uniform mixing of diluting liquid in the slurry stream entering the feedwell from the mixing conduit, but also serves to prevent a buildup of particles along the lower corners of the mixing conduit.

### BRIEF DESCRIPTION OF THE DRAWINGS

FIG. 1 is a vertical sectional view of a thickener/clarifier tank having a center pier supporting a rotating sludge raking structure and a feedwell assembly with a feed dilution system in accordance with the present invention. FIG. 2 is a plan view of the thickener/clarifier tank of FIG. 1, taken on line II-II in FIG. 1.

FIG. 3 is a schematic perspective view of a feedwell assembly with a feed slurry dilution system in accordance with the present invention.

FIG. 4 is a schematic vertical cross-sectional view of the feed dilution system of FIG. 3.

FIG. 5 is a side view of a check valve type nozzle shown in FIG. 4 and utilizable in the feed dilution system and method of the present invention.

FIG. 6 is an end view of the check valve type nozzle of FIGS. 4 and 5, showing an outlet orifice in a closed, storage and transport configuration.

FIG. 7 is an end view of the check valve type nozzle of FIGS. 4-6, showing the outlet orifice of the nozzle in one configuration during operation of the feed dilution system of the present invention.

FIG. 8 is a view similar to FIG. 7, showing the outlet orifice of the nozzle in another configuration during operation of the feed dilution system of the present invention.

FIG. 9A is a top view of a retaining clamp for the check valve type nozzle of FIGS. 4-8.

FIG. 9B is a side view of the retaining clamp of FIG. 9A.

### DETAILED DESCRIPTION

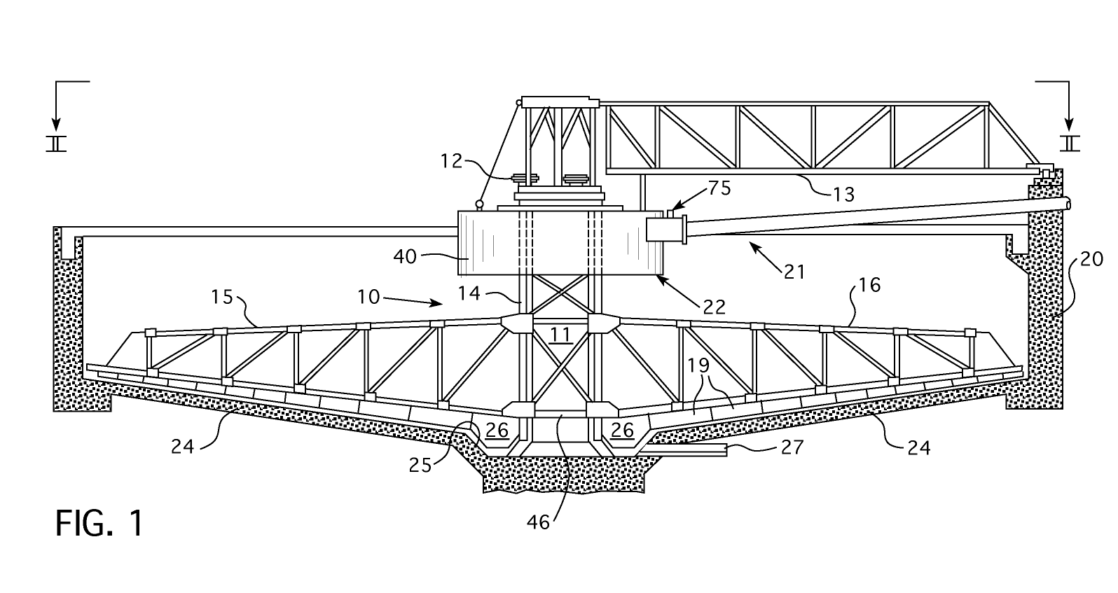

As illustrated in FIGS. 1 and 2, a thickener/clarifier comprises a continuously operating thickening/settling tank 20 wherein a sludge raking structure 10 is supported for rotation upon a center pier 11. A drive mechanism 12 of any suitable known construction is mounted atop the pier providing the driving torque for the rake structure. The pier also supports the inner end of an access bridge 13.

Rake structure 10 comprises a central vertical cage portion or cage 14 surrounding the pier 11, and rake arms of girder like construction extending rigidly from the cage. Rake structure 10 has one pair of long rake arms 15 and 16 opposite to one another, and a pair of short rake arms 17 and 18 disposed at right angles thereto, all arms having sludge impelling or conveying blades 19 fixed to the underside thereof.

Rake structure 10 operates in a settling tank 20 to which a feed suspension or feed pulp is supplied through a feed dilution system 21 terminating in a cylindrical feedwell body 22 which surrounds the top end portion of the rake structure and is supported by pier 11.

Tank 20 may be of usual construction, comprising a bottom 24 of shallow inverted conical inclination, and formed with an annular sump 25 around the pier, to which settled solids or sludge are conveyed by rake structure 10. Scraper blades 26, unitary with rake structure 10 and substantially conforming to the profile of sump 25, move the collected sludge to a point of delivery from the sump, as by way of a discharge pipe 27.

Feed slurry dilution system 21 is connected at a downstream end to feedwell body 22. Feedwell body 22 has an annular floor panel 34 (FIG. 2) with an inner edge 36 defining a circular opening 38 and an outer edge contiguous with a cylindrical sidewall 40 of the feedwell body. Feed slurry dilution system 21 is connected to feedwell body 22 so as to deliver slurry stream 42 to flow along a circular path inside the feedwell body. Slurry stream 42 has a substantially circular inner boundary located generally above inner edge 36 and a substantially circular outer boundary located adjacent feedwell sidewall 40. The inner and outer boundaries extend parallel to the path of the incoming slurry stream 42.

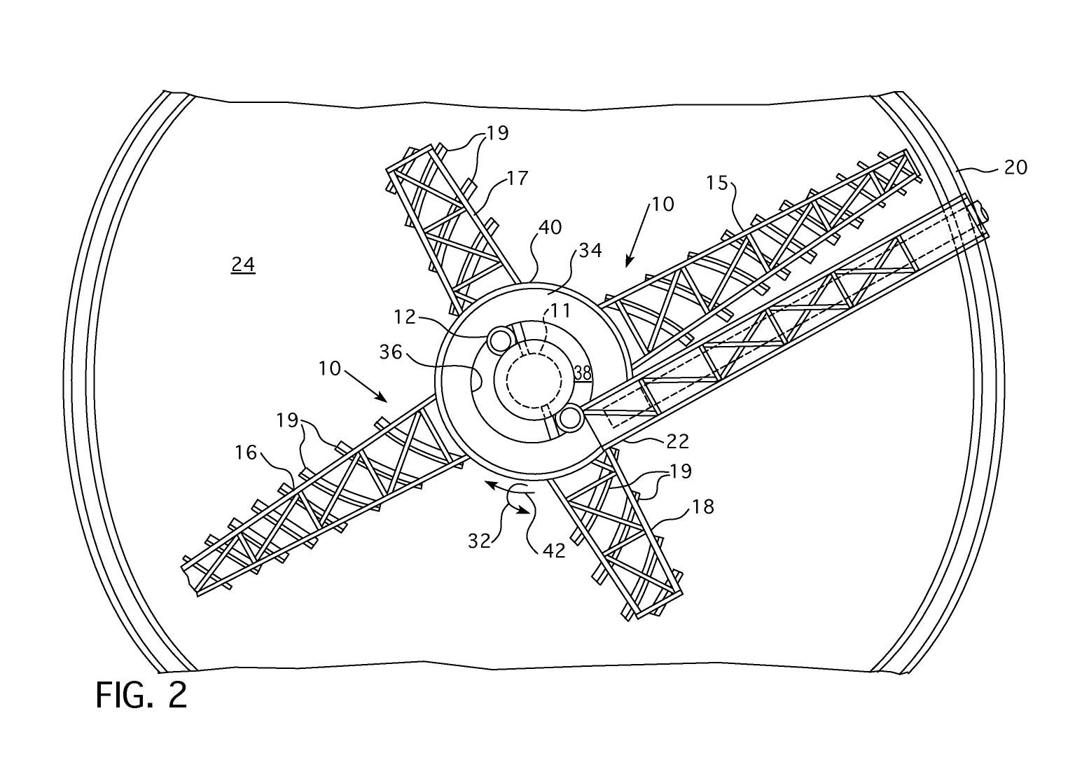

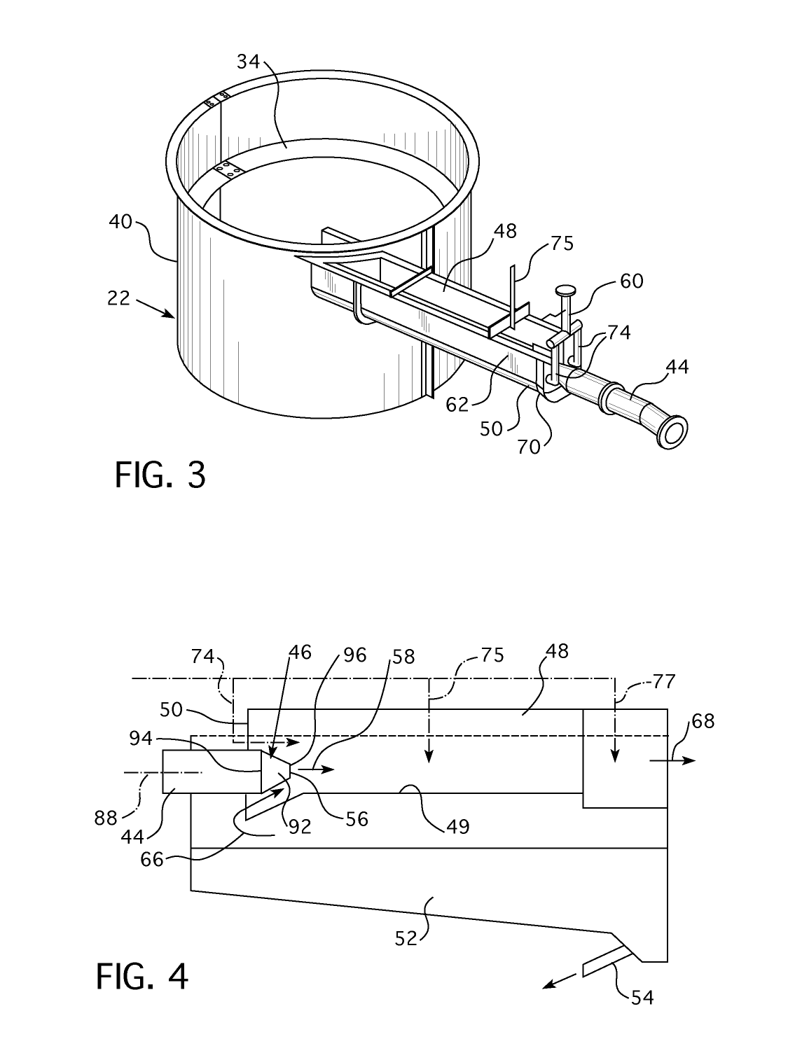

As depicted in FIG. 3 and more schematically in FIG. 4, feed dilution system 21 includes a slurry feed pipe 44, a variable-orifice nozzle 46 attached to a downstream end of the feed pipe, a source of diluting liquid, in this case flow 66 from the generally more clarified zone of the thickener or settling tank, and a mixing conduit 48 in the form of an open channel having lower corners 49 (only one shown). Feed dilution system 21 may be defined to further include feedwell body 22. At least a portion of nozzle 46 is disposed proximate an upstream end 50 of mixing conduit 48. A downstream end of mixing conduit 48 is functionally attached to feedwell sidewall 40 so that the mixing conduit communicates with the feedwell. In FIG. 4, reference designation 52 represents a bed of settled solids in settling tank 20, pipe 54 being provided for removing the thickened underflow.

Nozzle 46 (FIG. 4) generally comprises a nozzle body 92 having an inlet end 94 and an outlet end 96, the outlet end being provided with an outlet opening or orifice 56 having a size or cross-sectional area that varies in accordance with the pressure in feed pipe 44. The positioning of nozzle 46 relative to upstream end 50 of mixing conduit 48 may form an eductor structure for the diluting liquid, as generally shown in FIGS. 3 and 4 and/or also as generally described in U.S. Pat. No. 5,389,250.

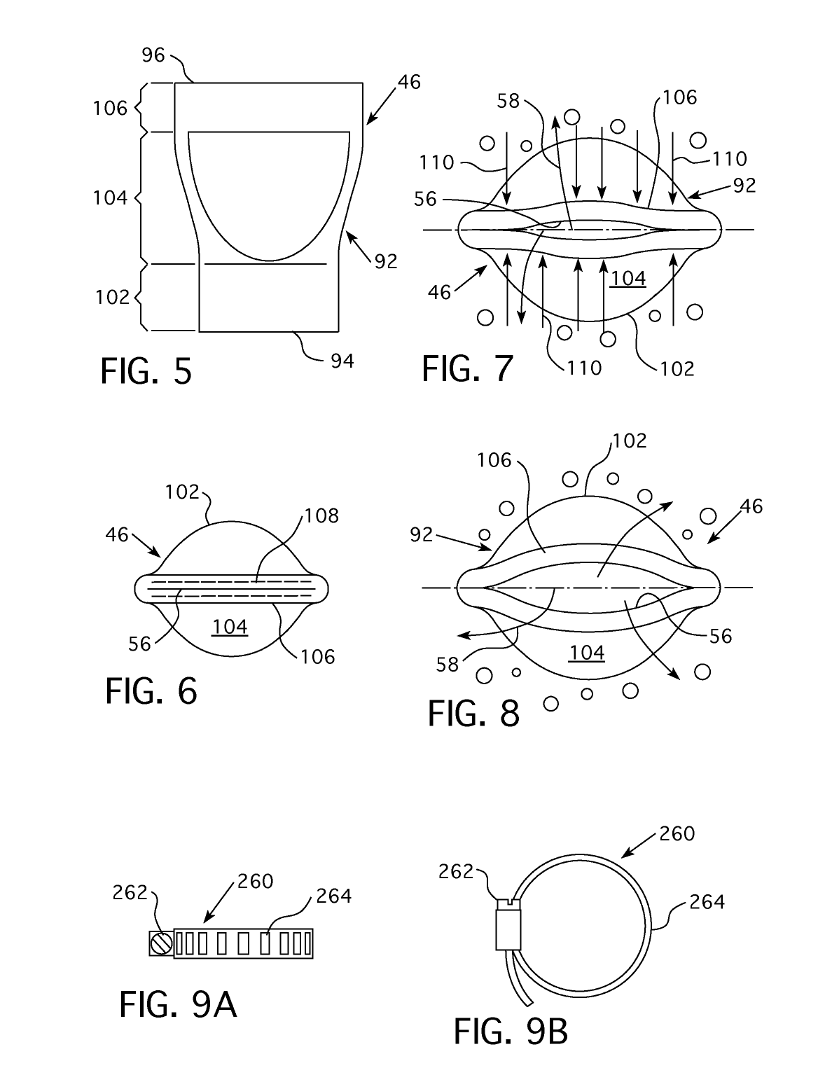

As shown in FIG. 5, variable-orifice nozzle 46 may take the form of an elastomeric duck bill type check valve nozzle which is self regulating with respect to flow therethrough and self cleaning. Nozzle 46 includes a cuff portion 102 at one end thereof having a substantially full round bore therethrough to resiliently slip over a downstream end of the feed pipe 44. Nozzle 46 further includes a saddle portion 104 in a middle region of the nozzle and a substantially flat bill portion 106 at the downstream or outlet end of the nozzle. Saddle portion 104 tapers from the substantially full round bore of cuff portion 102 to the substantially flat bill portion 106 thereby lending the nozzle a generally tapered cross-sectional shape. Bill portion 106 is substantially flat and is provided with outlet opening or orifice 56 in the form of a slit. Preferably outlet slit 56 is oriented substantially horizontally within the upstream or inlet end of mixing conduit 48. However, it should be understood that outlet slit 56 may have an orientation in any suitable direction within the mixing conduit 48.

Saddle portion 104 of nozzle 46 directs fluid flow to the bill portion 106 and is resilient to sustain the shape thereof regardless of changes in the fluid flow conditions in feed pipe 44 and nozzle 46. Bill portion 106 flexes to allow fluid flow through the substantially longitudinal outlet slit 56 therein and is resilient to vary the degree of opening of outlet slit 56 in conformity with the fluid pressure in feed pipe 44 and nozzle 46. More particularly, bill portion 106 flexes to vary the size or flow cross-section of outlet slit 56 so that a fluid stream 58 emerging from outlet slit 56 has an approximately constant velocity.

Outlet slit 56 may be of any suitable length, for instance, in a range of an inch or two to approximately the diameter of feed pipe 44. Nozzle 46 may be made of any suitable flexible or elastomeric material, such as rubber, neoprene, ceramics, composites, etc. suitable for use in the feed and dilution process, and may include fabric or wire reinforcing 108 therein as required. Nozzle 46 is self-cleaning since any build-up of material thereon will be removed by the flexing of the nozzle in response to changing fluid flow therethrough. Nozzle 46 is self-regulating as the resiliency of the nozzle and the flexure of the nozzle in reaction to the fluid therearound will determine the degree of opening of outlet slit 56, that is, the size or flow cross-section thereof.

As illustrated in FIG. 6, nozzle 46 is shown in an end view illustrating the substantially longitudinal slit 56 in the bill portion 106 and the reinforcement 108 thereof. Bill portion 106 of nozzle 46 is substantially the width of the cuff portion 104 if the cuff portion were flattened from its substantially cylindrical shape of the full round bore configuration.

FIG. 7 shows a configuration of nozzle 46 and particularly outlet slit 56 when the fluid pressure inside feed pipe 44 is relatively low, that is, low relative to the fluid pressure 110 inside mixing conduit 48. Internal spring stresses in bill portion 106 together with the external pressure 110 hold slit 56 in a nearly closed configuration at low pipe pressures so as to maintain the emerging fluid stream 58 approximately at a predetermined velocity. In contrast, FIG. 8 shows a configuration of nozzle 46 and particularly outlet slit 56 when the fluid pressure inside feed pipe 44 is higher. The higher pressures force slit 56 to open to a wider configuration, in opposition to the internal spring-biasing stresses of bill portion 106 and the fluid pressure 110 inside mixing conduit 48, still maintaining the emerging fluid stream 58 approximately at the same predetermined velocity. The internal spring-biasing stresses of bill portion 106 arise from the resiliency of nozzle 46 due the characteristics of the elastomeric material of the nozzle and any reinforcement material or means 108 located therein additionally keep the nozzle 46 in a closed configuration.

With reference to FIGS. 9A and 9B, a suitable mechanical clamp 260 is shown to retain the nozzle 46 on the end of feed pipe 44. Clamp 260 comprises any suitable mechanically actuated clamp such as a screw 262 retained on one end of a clamp member 264 engaging a plurality of apertures in the clamp member 264. Since nozzle 46 resiliently engages the end of feed pipe 44, typically only a small clamping force is required to retain the nozzle 46 on the end of the feed pipe so that a variety of clamps are suitable.

The present invention further includes a method of conditioning a slurry feed stream flowing into the feedwell of a thickening or settling tank, where the tank includes a tank inlet system comprising an influent slurry feed pipe, nozzle and orifice directing the influent slurry feed stream into a mixing conduit, the mixing conduit including a bottom and leading to the feedwell. The method exemplarily uses the apparatus described hereinabove.

This method includes the steps of flowing the influent slurry feed stream through the feed pipe, nozzle and orifice into the mixing conduit, using the nozzle orifice to shape the influent slurry feed stream so that the influent feed stream has a substantially constant velocity on an output side of the orifice.

The method contemplates that using the feed pipe orifice includes changing or managing the shape and/or the opening size of the feed pipe orifice. The feed pipe orifice may be provided in an elastomeric check valve type nozzle configured and arranged to shape the influent feed stream according to the method. The nozzle may take the particular form of a duckbill type nozzle configured and arranged to shape the influent feed stream into a flattened cross-section. Other types of nozzles may be used provided that they have an outlet orifice of variable size and/or shape that compensates for changes in infeed pressure to provide an output or emerging slurry stream of substantially constant velocity.

The feed pipe orifice is made at least in part of resilient and flexible material configured and arranged to shape the influent feed stream according to the method.

The method preferably further comprises feeding a diluting liquid to the mixing conduit to mix with the influent slurry feed stream, wherein the using of the feed pipe orifice to shape the influent feed stream so that the influent feed stream has a constant velocity ensures a substantially uniform degree of dilution of the influent slurry feed stream by the diluting liquid.

The method could also include the educting of the flow of the diluting liquid into the mixing conduit, or otherwise, by using the transfer of momentum between the influent slurry feed stream and the diluting liquid, flocculating the incoming diluting liquid and/or the slurry feed stream and the diluting liquid within the mixing conduit or otherwise, and/or producing a substantially uniform solids concentration within the resulting diluted and mixed slurry feed stream flowing into the feedwell.

Although the invention has been described in terms of particular embodiments and applications, one of ordinary skill in the art, in light of this teaching, can generate additional embodiments and modifications without departing from the spirit of or exceeding the scope of the claimed invention. It is believed that the invention is useful in virtually any type of feedwell assembly, with or without the addition of flocculent, with or without slurry dilution by eduction, with singular or multiple infeed paths, with or without spill lips (i.e., annular bottom panels or shelves in the feedwell bodies), etc. Accordingly, it is to be understood that the drawings and descriptions herein are proffered by way of example to facilitate comprehension of the invention and should not be construed to limit the scope thereof which is only defined by the broadest possible interpretation of the appended claims and their equivalents.

Furthermore, a contractor or other entity may provide, or be hired to provide, the apparatus and/or method such as those disclosed in the present specification and shown in the figures. For instance, the contractor may receive a bid request for a project related to designing a system for producing a particular slurry feed stream or may offer to design such a method and accompanying system. The contractor may then provide the apparatus and/or method such as those discussed above. The contractor may provide such a method by selling the apparatus and/or method or by offering to sell the apparatus and/or method, and/or the various accompanying parts and equipment to be used with and/or for said method. The contractor may provide a method and/or related equipment that are configured to meet the design criteria of a client or customer. The contractor may subcontract the fabrication, delivery, sale, or installation of a component of, or of any of the devices or of other devices contemplated for use with the method. The contractor may also maintain, modify or upgrade the provided devices and their use within the general method. The contractor may provide such maintenance or modifications by subcontracting such services or by directly providing those services.

What is claimed is:

1. A feed slurry dilution system for a thickener or settling tank, comprising:
a slurry feed pipe;
a nozzle attached to a downstream end of said feed pipe, said nozzle having a variable orifice configured to provide an infeed slurry flow stream of substantially constant velocity;
a mixing conduit, at least a portion of said nozzle being disposed proximate an upstream end of said mixing conduit;
a source of diluting liquid to said mixing conduit; and
a feedwell disposed inside the thickener or settling tank, a downstream end of said mixing conduit being functionally attached to said feedwell so that said mixing conduit communicates with said feedwell.

2. The feed slurry dilution system of claim 1 wherein said nozzle has an outlet orifice portion made of resilient and flexible material.

3. The feed slurry dilution system of claim 2 wherein said nozzle is an elastomeric check valve type nozzle.

4. The feed slurry dilution system of claim 3 wherein said nozzle is a duckbill type nozzle.

5. The feed slurry dilution system of claim 1 wherein said mixing conduit is in the form of an open channel.

6. The feed slurry dilution system of claim 1 wherein said mixing conduit has a rectangular cross-section with a pair of lower corners, said nozzle having an outlet opening configured to bias said infeed slurry flow stream to remove settled particles from said corners.

7. The feed slurry dilution system of claim 1 wherein the source of diluting liquid to said mixing conduit includes an eductor structure.

8. A method of conditioning a slurry feed stream flowing into the feedwell of a thickening or settling tank, said tank including a tank inlet system comprising an influent slurry feed pipe and orifice directing the influent slurry feed stream into a mixing conduit, said mixing conduit including a source of diluting liquid and a bottom and leading to the feedwell, said method comprising the steps of:
flowing the influent slurry feed stream through the feed pipe and orifice into the mixing conduit and using the feed pipe orifice to manage the influent feed stream so that the influent feed stream has a substantially constant velocity on an output side of said orifice;
introducing diluting liquid into the mixing conduit;
mixing the influent slurry feed stream and diluting liquid within the mixing conduit thereby forming a diluted and mixed slurry feed stream; and
flowing the resulting diluted and mixed slurry feed stream into the feedwell.

9. The method of claim 8 wherein the using of said feed pipe orifice includes changing the shape of said feed pipe orifice.

10. The method of claim 9 wherein said feed pipe orifice is provided in an elastomeric check valve type nozzle configured and arranged to shape the influent feed stream according to the method.

11. The method of claim 10 wherein said nozzle is a duckbill type nozzle configured and arranged to shape the influent feed stream into a flattened cross-section and according to the method.

12. The method of claim 9 wherein said feed pipe orifice is made at least in part of resilient and flexible material configured and arranged to shape the influent feed stream according to the method.

13. The method of claim 8 wherein the using of the feed pipe orifice to manage the influent feed stream so that the influent feed stream has a constant velocity ensures a substantially uniform degree of dilution of said influent slurry feed stream by said diluting liquid.

14. The method of claim 13, further comprising introducing the diluting liquid into the mixing conduit by way of educting the flow of the diluting liquid into the mixing conduit using the transfer of momentum between the flow of the influent slurry feed stream and the diluting liquid.

15. The method of claim 14, further comprising the step of flocculating the educted diluting liquid.

16. The method of claim 14, further comprising the step of flocculating the slurry feed stream and the diluting liquid within the mixing conduit.

17. The method of claim 14, further comprising the step of producing a substantially uniform solids concentration within the resulting diluted and mixed slurry feed stream flowing into the feedwell.

18. The method of claim 9 wherein changing the shape of the orifice in turn shapes the influent feed stream according to the method.
